(19) United States
(12) Patent Application Publication
(10) Pub. No.: US 2014/0301102 A1
(43) Pub. Date: Oct. 9, 2014

(54) MULTI-ARRAY LED CHIP FOR EMBODYING CUT-OFF LINE AND HEAD LAMP HAVING THE SAME

(71) Applicant: HYUNDAI MOBIS CO. LTD., Seoul (KR)

(72) Inventor: Seong Yeon HAN, Yongin (KR)

(73) Assignee: HYUNDAI MOBIS CO. LTD., Seoul (KR)

(21) Appl. No.: 14/183,442

(22) Filed: Feb. 18, 2014

(30) Foreign Application Priority Data
Apr. 8, 2013 (KR) 10-2013-0038240

(51) Int. Cl. F21S 8/10; F21K 99/00

(52) U.S. Cl. CPC F21S 48/115; F21K 9/50
USPC 362/520; 362/249.02

(57) ABSTRACT

The present invention relates to a multi-array LED chip for embodying a cut-off line, and the multi-array LED chip includes: a plurality of LED modules which emits light; and at least one low beam LED module which emits light, in which the LED module and the low beam LED module are disposed to match a cut-off line, and the LED module and the low beam LED module are individually turned on and off such that a low beam is emitted. Accordingly, a direct type of light is emitted, and thus a low beam, which complies with regulations regarding the cut-off line, is embodied, and light efficiency does not deteriorate.

### CROSS-REFERENCE TO RELATED APPLICATIONS

This application claims priority to and the benefit of Korean Patent Application No. 10-2013-0038240 filed in the Korean Intellectual Property Office on Apr. 8, 2013, the entire contents of which are incorporated herein by reference.

### TECHNICAL FIELD

The present invention relates to a multi-array LED chip. More particularly, the present invention relates to a multi-array LED chip, which embodies a low beam by turning on and off LED modules of the multi-array LED chip so as to comply with regulations regarding the cut-off line, and a head lamp having the multi-array LED chip.

### BACKGROUND ART

In general, lighting devices are provided in a vehicle in order to stably secure visibility for a driver even when illumination is low at the periphery of the vehicle at the time of driving vehicle, and among the lighting devices, a head lamp device is classified into a high beam device and a low beam device based on a difference in irradiation angle of light and a difference in amount of light which is emitted from the lamp.

An LED head lamp using a light emitting diode (LED) has been developed as a light source of the head lamp for a vehicle.

Here, the light emitting diode (LED) is a diode that emits excess energy as light when injected electrons and holes are coupled again, emits red light or green light, and is mainly used as a light source for an optical coupled element using advantages of low voltage and low electric power consumption.

In this regard, as a related art, there is Korean Patent Application Laid-Open No. 10-2005-0103391 entitled ‘Light Distribution Structure of LED Head Lamp for Vehicle’.

In the light distribution structure of the LED head lamp for a vehicle, a light concentration structure of the LED head lamp is described, as illustrated in FIG. 1.

When describing the light concentration structure of the LED head lamp with reference to FIG. 1, a light concentration structure 10 of the LED head lamp may include an LED light source 11, a reflector 12 which adjusts a direction of light from the LED light source 11, a lens 13 which protects the LED light source 11, and a shade or shield 14 which cuts off light emitted toward an opposite vehicle so as to prevent light blindness to a driver in an oncoming vehicle.

Referring to FIG. 2 in detail, the light emitted from the LED light source 11 of the light concentration structure 10 of the LED head lamp has the shield 14 so as to satisfy cut-off regulations when a low beam is formed, but there is a problem in that light efficiency is reduced due to light shielding by the shield 14.

Particularly, as illustrated in FIG. 3, because vibrations is caused in a case in which a mechanical drum shield 14a is applied to the head lamp, there are problems in that a fastening structure becomes widened such that a mechanical gap is caused and a lifespan is decreased, and deformation in the fastening structure is caused. There is also a problem in that operational noise is generated.

### SUMMARY OF THE INVENTION

The present invention has been made in an effort to provide a multi-array LED chip for embodying a direct type cut-off line and a head lamp having the same, which embody a low beam without using a reflector, a shield, and an actuator which drives the shield, which are constituent elements of a head lamp in the related art.

An exemplary embodiment of the present invention provides a multi-array LED chip for embodying a cut-off line, including: a plurality of LED modules which emits light; and at least one low beam LED module which emits light, in which the LED module and the low beam LED module are disposed to match a cut-off line, and the LED module and the low beam LED module are individually turned on and off such that a low beam is embodied.

The low beam LED module may include an isolation region which is formed in a diagonal direction along the cut-off line so as to separate internal electrodes.

The low beam LED module may include a plurality of LED units which is divided along the cut-off line.

The LED unit, which is disposed on a plane on an emission line of light, may have a right-angled triangle shape, and a gradient on plane of a surface, which is formed along the cut-off line, may be 15° to 45°.

The LED unit, which is disposed on a plane on an emission line of light, may be formed by disposing a plurality of LED segment units.

The LED segment units may be individually turned on.

Another exemplary embodiment of the present invention provides a head lamp including: the multi-array LED chip for embodying a cut-off line; and an aspherical lens which is installed on an emission line of light which is emitted from the multi-array LED chip.

According to the multi-array LED chip for embodying a cut-off line according to the present invention, a direct lighting type of light is emitted, and thus a low beam, which complies with regulations regarding the cut-off line, is embodied, and light efficiency does not deteriorate.

Even in a case in which a reflector, a shield, and an actuator which drives the shield, which are constituent elements of a head lamp in the related art, are not installed, the multi-array LED chip for embodying a cut-off line according to the present invention may embody a low beam having increased light efficiency.

Accordingly, the head lamp having the multi-array LED chip for embodying a cut-off line according to the present invention does not have constituent elements of a head lamp in the related art, and thus a weight of the head lamp may be reduced, and the head lamp may be simplified.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1 and 2 are views illustrating a light distribution structure of an LED head lamp for a vehicle in the related art.

FIG. 3 is a view illustrating the LED head lamp for a vehicle which includes a drum shield in the related art.

FIG. 4 is a view illustrating a multi-array LED chip for embodying a cut-off line according to an exemplary embodiment of the present invention, and a result of distributing light.

FIG. 5 is a cross-sectional view taken along line A-A of FIG. 4.

FIG. 6 is a view illustrating another exemplary embodiment of a low beam LED module of the multi-array LED chip for embodying a cut-off line according to the present invention.

FIG. 7 is a view illustrating an exemplary embodiment of an LED unit of the low beam LED module.

FIG. 8 is a view illustrating another exemplary embodiment of the LED unit of the low beam LED module.

FIG. 9 is a view illustrating a head lamp for a vehicle which has the multi-array LED chip for embodying a cut-off line according to the exemplary embodiment of the present invention.

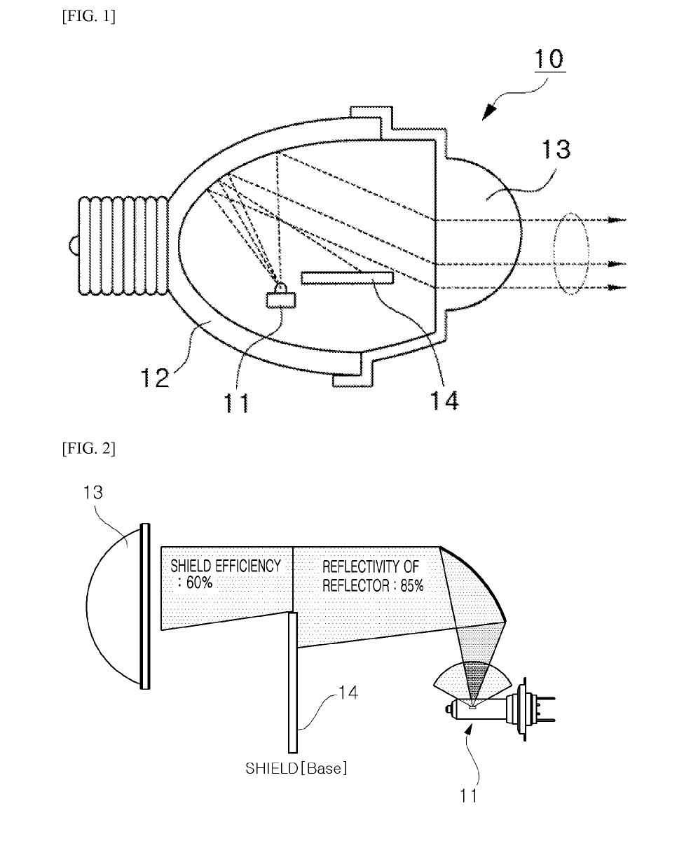

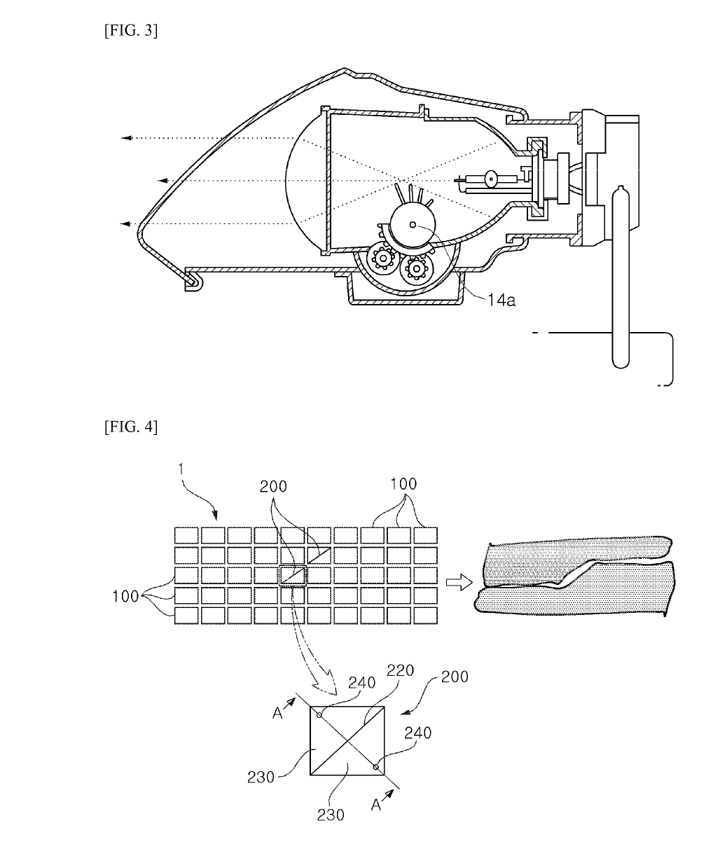

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings in order to clarify a method of solving the technical problems of the present invention. However, in the description of the present invention, descriptions of publicly-known related technologies incorporated herein will be omitted when it is determined that the descriptions of the publicly-known related technologies may obscure the subject matter of the present invention. The terms used in the following description are defined considering the functions of the present invention and may vary depending on the intention or usual practice of a designer or manufacturer. Therefore, the definitions should be made based on the entire contents of the present specification. Parts indicated by like reference numerals (reference numbers) refer to like elements throughout the specification.

Hereinafter, a multi-array LED chip 1 for embodying a cut-off line according to an exemplary embodiment of the present invention will be described.

Referring to FIGS. 4 to 6, the multi-array LED chip 1 may include a plurality of LED modules 100 which emits light, and at least one low beam LED module 200 which emits light.

The LED module 100 and the low beam LED module 200 are a light source having a light emitting diode (LED) installed therein, and emit light. However, the low beam LED module 200 is turned on to emit light toward an inner side of a cut-off boundary line in order to comply with regulations regarding a cut-off line.

That is, as illustrated in FIG. 4, the plurality of LED modules 100 and the at least one low beam LED module 200 are disposed to match the cut-off line so as to emit a low beam, and the multi-array LED chip 1 embodies a low beam by turning on and off each of the plurality of LED modules 100 and the at least one low beam LED module 200.

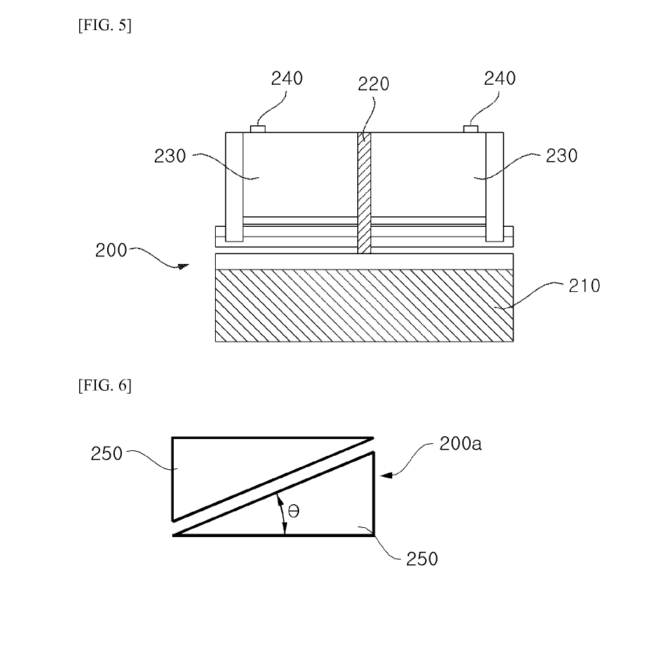

Meanwhile, as illustrated in FIGS. 4 and 5, the low beam LED module 200 may include an isolation region which is formed in a diagonal direction along the cut-off line so as to separate internal electrodes.

That is, the low beam LED module 200 may include a substrate 210, an isolation region 220 which is installed on the substrate 210, light emission regions 230 which are partitioned by the isolation region 220, and chip electrodes 240 which are individually installed on the light emission regions 230.

Therefore, the low beam LED module 200 is partitioned by the isolation region 220, and the chip electrodes 240 are individually provided on the light emission regions 230, such that each of the partitioned light emission regions 230 may be individually turned on.

Accordingly, the predetermined light emission regions 230 of the low beam LED module 200 may be turned on to correspond to the cut-off line together with the LED module 100, thereby embodying a low beam as illustrated in FIG. 4.

Meanwhile, a low beam LED module 200a may be formed by a plurality of LED units 250 which is divided along the cut-off line.

For example, as illustrated in FIG. 6, the low beam LED module 200a, which is viewed on an emission line of light, may be formed as two LED units 250 which have a right-angled triangle shape and are divided along the cut-off line. A gradient of θ on plane of a surface, which is formed along the cut-off line, may be determined within a range of 15° to 45°. Here, an angle of θ is a range in which the multi-array LED chip 1 forms the cut-off line.

Of course, a shape of the LED unit 250 is not particularly limited to the aforementioned right-angled triangle shape, and instead of the LED unit 250 having the right-angled triangle shape, the LED unit may also be formed by disposing and combining polygonal LED units as long as a condition in which the LED units are divided along the cut-off line is satisfied.

A circuit may be designed so that each of the LED units 250 may be individually turned on. Accordingly, each of the LED units 250 may be individually turned on and inspected.

Meanwhile, the LED unit 250 may be formed by disposing a plurality of LED segment units 251 and 252.

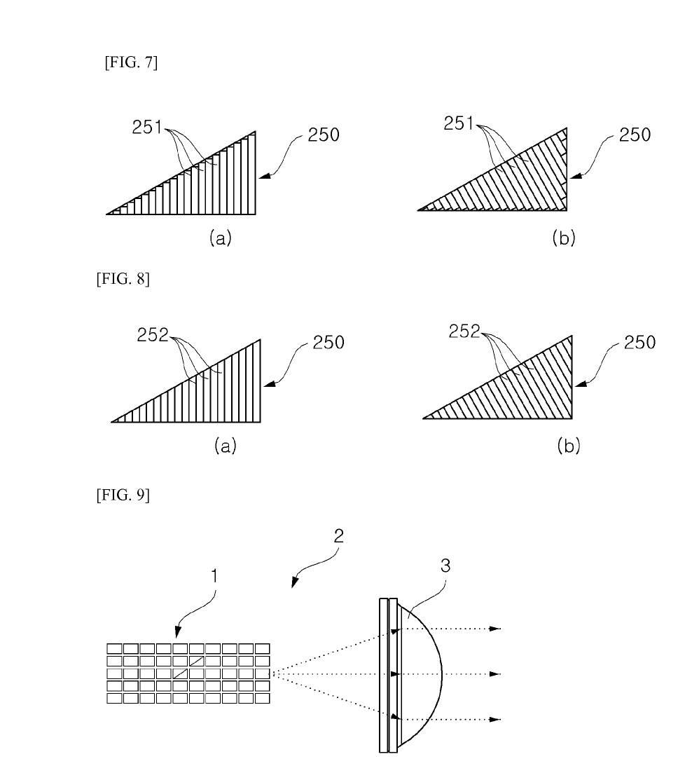

The plurality of LED segment units 251, which has different lengths and quadrangular shapes, may be disposed in parallel so that one edge of each of the plurality of LED segment units 251 is in direct contact with the cut-off line, as illustrated in FIG. 7A, or the plurality of LED segment units 251 may be disposed in parallel so that one surface of each of the plurality of LED segment units 251 is in direct contact with the cut-off line, as illustrated in FIG. 7B.

The LED segment units 252, each of which has a quadrangular shape and one surface having a gradient identical to that of the cut-off line, may be disposed so that the one surface having the gradient matches the cut-off line, as illustrated in FIG. 8A, or may be disposed so that the one surface having the gradient is positioned at the opposite side to a surface that matches the cut-off line, as illustrated in FIG. 8B.

A circuit may be designed so that each of the LED segment units 251 and 252 may be individually turned on. Accordingly, each of the LED segment units 251 and 252 may be individually turned on and inspected.

To sum up, the LED module 100, the light emission regions 230 of the low beam LED modules 200 and 200a, the LED units 250, and the LED segment units 251 and 252 are individually turned on and off, and as a result, the multi-array LED chip 1 achieves an effect identical to a low beam which is not emitted above a predetermined height as a cut-off boundary line is formed by a shield in the related art. Accordingly, visibility for a driver in an oncoming vehicle is not hindered.

Hereinafter, a head lamp 2, which has the multi-array LED chip for embodying a cut-off line according to the exemplary embodiment of the present invention, will be described.

Referring to FIG. 9, the head lamp 2 refers to a head lamp for a vehicle, and may include the multi-array LED chip 1, and an aspherical lens 3 which is installed on an emission line of light that is emitted from the multi-array LED chip 1.

Accordingly, the light emitted from the multi-array LED chip 1 is guided into an irradiation range of the aspherical lens 3.

Therefore, in the head lamp 2, a problem, which reduces light efficiency due to light shielding phenomenon by a shield in the related art, also does not occur.

The head lamp 2 may further include a lens (not illustrated) which disposed between the multi-array LED chip 1 and the aspherical lens 3 so as to improve light quality.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A multi-array LED chip for embodying a cut-off line, comprising:
a plurality of LED modules which emits light; and
at least one low beam LED module which emits light,
wherein the LED module and the low beam LED module are disposed to match a cut-off line, and the LED module and the low beam LED module are individually turned on and off such that a low beam is embodied.

2. The multi-array LED chip of claim 1, wherein the low beam LED module includes an isolation region which is formed in a diagonal direction along the cut-off line so as to separate internal electrodes.

3. The multi-array LED chip of claim 1, wherein the low beam LED module includes a plurality of LED units which is divided along the cut-off line.

4. The multi-array LED chip of claim 3, wherein the LED unit, which is disposed on a plane on an emission line of light, has a right-angled triangle shape, and a gradient on plane of a surface, which is formed along the cut-off line, is 15° to 45°.

5. The multi-array LED chip of claim 3, wherein the LED unit, which is disposed on a plane on an emission line of light, is formed by disposing a plurality of LED segment units.

6. The multi-array LED chip of claim 5, wherein the LED segment units are individually turned on.

7. A head lamp comprising:
The multi-array LED chip of claim 1, and
an aspherical lens which is installed on an emission line of light which is emitted from the multi-array LED chip.

8. The head lamp of claim 7, wherein the low beam LED module includes an isolation region which is formed in a diagonal direction along the cut-off line so as to separate internal electrodes.

9. The head lamp of claim 7, wherein the low beam LED module includes a plurality of LED units which is divided along the cut-off line.

10. The head lamp of claim 9, wherein the LED unit, which is disposed on a plane on an emission line of light, has a right-angled triangle shape, and a gradient on plane of a surface, which is formed along the cut-off line, is 15° to 45°.

11. The head lamp of claim 9, wherein the LED unit, which is disposed on a plane on an emission line of light, is formed by disposing a plurality of LED segment units.

12. The head lamp of claim 11, wherein the LED segment units are individually turned on.
